(19) United States
(12) Patent Application Publication
(10) Pub. No.: US 2024/0080964 A1
(43) Pub. Date: Mar. 7, 2024

(54) METHOD OF PROVIDING A MARKING TO A SOLID-STATE MATERIAL, MARKINGS FORMED FROM SUCH A METHOD AND SOLID-STATE MATERIALS MARKED ACCORDING TO SUCH A METHOD

(71) Applicant: GOLDWAY TECHNOLOGY LIMITED, Hong Kong (CN)

(72) Inventors: Yingnan WANG, Hong Kong (CN); Jianxing HUANG, Hong Kong (CN)

(73) Assignee: GOLDWAY TECHNOLOGY LIMITED, Hong Kong (CN)

(21) Appl. No.: 18/267,132

(22) PCT Filed: Dec. 14, 2021
(86) PCT No.: PCT/CN2021/137715

§ 371 Date: Jun. 14, 2023

(30) Foreign Application Priority Data
Dec. 14, 2020 (HK) 32020022100.2

(51) Int. Cl. H05H 1/46

(52) U.S. Cl. CPC H05H 1/46; H05H 2245/40

(57) ABSTRACT

A method of forming an identifiable marking at an outer surface of a plurality of articles formed from a solid-state material, wherein each marking is formed from one or more recesses extending from the outer surface and into the article, said method including the steps of (i) providing at least a first mask having a first surface and a second surface and having a plurality of mask patterns, wherein each mask pattern is formed by one or more apertures extending through the mask from the first surface and to the second surface, and wherein the pattern is indicative of the shape of marking to be formed; (ii) affixing a plurality of articles formed from a solid-state material relative to the mask such that an outer surface of each article of the plurality of articles is affixed adjacent a mask pattern and adjacent the first surface of the mask; and (iii) applying a plasma etching process in a direction of from towards the second surface of the mask and towards the plurality of articles, wherein the outer surface of each article exposed to the plasma etching through the apertures in the mask has a marking formed thereon by one or more recesses etched by the plasma etching process.

### TECHNICAL FIELD

The present invention relates to the field of providing markings to solid state materials, and more particularly to the marking of gemstones including diamonds.

### BACKGROUND OF THE INVENTION

As is known, gemstone, including diamonds, identification and grading has been long-established by international standards laboratories such as including GIA, IGI, Gem-A and NGTC.

Also as is known, the identification and grading result is typically stored in an electronic media such as hard-disks, tapes, compact discs and the like, and a paper certificate is issued along with the corresponding gemstone.

When a certificate is lost or destroyed, or when the gemstone is mixed with other gemstones, the identity of the gemstone is effectively lost, and is required to be recertified.

Direct marking applied to gemstones, including diamonds, is a generally straight-forward implementation in order to avoid such circumstance and allows for re-identification of the gemstone.

Conventional techniques known within the art for the marking of gemstones including diamonds include laser marking, and also ion beam marking.

However, when using laser marking, this has been shown to generate coarse patterns and can leave unrecoverable ablation marks on the gemstone, causing permanent damage and which can cause devaluation the gemstone, and in some cases discernable blemishes and defects.

When using ion beam marking, such a technique can be used to inscribe fine patterns on the surface of a gemstone, which can be 1000 times smaller than those when using laser marking, however the process is typically relatively slow and requires precision.

Other than item identification, gemstone marking can provide traceability of an item such that its origin, its owner, and its features and the like.

Such marking techniques can also assist in the prevention of the counterfeiting of precious articles such as artworks or jewellery, and be of assistance in the incident of theft.

### OBJECT OF THE INVENTION

It is an object of the present invention to provide a method for the marking of solid state materials, including gemstones, and an identification marking which overcomes or at least partly ameliorates at least some deficiencies as associated with the prior art.

### SUMMARY OF THE INVENTION

In a first aspect, the present invention provides a method of forming an identifiable marking at an outer surface of a plurality of articles formed from a solid-state material, wherein each marking is formed from one or more recesses extending from the outer surface and into the article, said method including the steps of:
(i) providing at least a first mask having a first surface and a second surface and having a plurality of mask patterns, wherein each mask pattern is formed by one or more apertures extending through the mask from the first surface and to the second surface, and wherein the pattern is indicative of the shape of marking to be formed;
(ii) affixing a plurality of articles formed from a solid-state material relative to the mask such that an outer surface of each article of the plurality of articles is affixed adjacent a mask pattern and adjacent the first surface of the mask; and
(iii) applying a plasma etching process in a direction of from towards the second surface of the mask and towards the plurality of articles, wherein the outer surface of each article exposed to the plasma etching through the apertures in the mask has a marking formed thereon by one or more recesses etched by the plasma etching process.

The plasma etching process may be microwave plasma etching, reactive-ion etching (RIE), or inductively-coupled plasma (ICP) etching.

The mask may be formed from a polymeric material. The mask may be formed from a polymeric film. The mask may be formed from a polyimide film.

The mask may have an adhesive substance applied to the first surface, and wherein the plurality articles are affixed relative to the mask by said adhesive substance. The adhesive substance may be a silicon adhesive substance.

The etching process is an ARDE (aspect ratio dependent etching) process.

The mask thickness may be in the range of from 10 μm to 800 μm, or in the range of from 25 μm to 400 μm, or in the range of from 40 μm to 200 μm. The mask may have a thickness of about 50 μm.

The apertures of mask pattern have a width of in the range of from 0.1 μm to 100 μm.

The aspect ratio of the mask thickness to the width of the apertures of the mask pattern is in the range of from 3:1 to 15:1.

The aspect ratio of the mask thickness to the width of the apertures of the mask pattern may be about 5:1.

Each mask pattern of the plurality of mask patterns may have the same as the other mask patterns.

Each mask pattern of the plurality of mask patterns differs from at least one of the other mask patterns.

Each mask pattern may be formed by a plurality of apertures extending through the mask.

The apertures of the mask patterns may have different sizes and shapes.

The mask pattern may be provided as an indicia, so as to provide for an indicia to be etched into the outer surface of the article.

The mask pattern may be provided as a serial number, so as to provide for a serial number to be etched into the outer surface of the article.

The mask pattern may be provided as a data code indicia, so as to provide for a data code indicia, to be etched into the outer surface of the article. The data code may be a QR code.

The marking may be an etched 2-dimensional marking or a 2.5-dimensional marking.

The width of the apertures of the pattern is of a constant width and the depth of the marking etched into the article is a constant depth.

The width of the apertures of the pattern may be of a varied width and the depth of the marking etched into the article is a varied depth.

The mask may be inclined at an angle with respect to the direction of the plasma etching process, such that a side surface of the edged marking is inclined with respect to the outer surface of the article in which the marking is etched, such that the marking is of a 3-dimensional form.

The marking has a depth in the range of from 10 nm to 30 nm. The marking has a depth of about 20 nm. The marking has a depth of about 25 nm.

The plasma etching step (iii) may be provided for a time in the range of between 10 minutes and 20 minutes.

The plasma etching step (iii) may be provided for a time of about 15 minutes.

The mask may have an adhesive substance applied to the first surface, and wherein the plurality articles are affixed relative to the mask surface by said adhesive substance, and said method further comprises a step (iv) of releasing the articles from the mask by releasing agent. The releasing agent may be acetone.

The apertures forming the patterns in the mask may be formed by way of a laser process. The laser process may be provided by a laser machining system.

The apertures forming the patterns in the mask may be formed by way of a focused ion beam process.

The solid state material from which the articles are formed may include a gemstone.

The gemstone may be a diamond, for example natural diamond, synthetic diamond, CVD diamond and HPHT diamond.

The gemstone may include ruby, sapphire and emerald.

The marking may be viewable by use of a 10× loupe or a 20× loupe. The marking may be viewable under a 5× or 10× microscope.

In a second aspect, the present invention provides an identifiable marking formed according to the method of the first aspect.

The marking may be viewable by use of a 10× loupe or a 20× loupe.

The marking may be viewable under a 5× or 10× microscope.

The marking may be viewable by naked eye.

In a third aspect, the present invention provides an article having thereon a marking formed according to the method of the first aspect.

The solid state material from which the article is formed may include a gemstone.

The gemstone may be diamond, for example natural diamond, synthetic diamond, CVD diamond and HPHT diamond.

The diamond may be a melee diamond.

The diamond may have a size of as low as 0.01 ct or a diameter of as low as about 1.3 mm

The gemstone may include ruby, sapphire and emerald.

The marking may be viewable by use of a 10× loupe or a 20× loupe.

The marking may be viewable under a 5× or 10× microscope.

In a fourth aspect, the present invention provides a system for forming an identifiable marking at an outer surface of a plurality of articles formed from a solid-state material, comprising:
a plurality of support devices for supporting at least a first mask having a first surface and a second surface and having a plurality of mask patterns, wherein each mask pattern is formed by one or more apertures extending through the mask from the first surface and to the second surface, and wherein the pattern is indicative of the shape of marking to be formed; and
a plasma etching system applying a plasma etching process in a direction of from towards the second surface of the mask and towards a plurality of articles, wherein the outer surface of each article exposed to the plasma etching through the apertures in the mask has a marking formed thereon by one or more recesses etched by the plasma etching process.

The system may further comprise a mask pattern forming device for providing and forming the mask patterns within the masks prior to the plurality of gemstones being placed upon the masks.

The system may further comprise a pick and place module for placing articles adjacent the mask patterns prior to etching the marking.

### BRIEF DESCRIPTION OF THE DRAWINGS

In order that a more precise understanding of the above-recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed.

The accompany drawings illustrate the present invention and explain its principle. In the drawings, like reference numbers refer to like parts throughout:

FIG. 1a-FIG. 1d shows a schematic representation of a first example of the method according to the present invention;

FIG. 2a-FIG. 2d shows a schematic representation of a second example of the method according to the present invention;

FIG. 3a-FIG. 3e shows a schematic representation of a third example of the method according to the present invention;

FIG. 4a-FIG. 4e shows a schematic representation of a fourth example of the method according to the present invention;

FIG. 5a-FIG. 5e shows a schematic representation of a fifth example of the method according to the present invention;

FIG. 6a shows a flow chart depicting an example of the method according to the present invention;

FIG. 6b shows a schematic representation of an embodiment of a system according to the present invention;

FIG. 7a shows a diamond releasably affixed to a mask having requisite apertures extending therethrough prior to etching of a marking in accordance with the present invention;

FIG. 7b shows the diamond of FIG. 7a with the marking thereon after etching in accordance with the present invention;

FIG. 8 shows an example of etch depth variation with line width of a mask when etching a marking in accordance with the present invention;

FIG. 9a and FIG. 9b show examples of a gemstone etched in accordance with the method of the present invention with a height of 300 micrometers;

FIG. 10a and FIG. 10b show examples of an emerald gemstone with a marking etched into the surface thereof utilizing the method of the present invention;

FIG. 10c shows an example of a CVD (chemical vapour deposition) plate with a marking etched into the surface thereof utilizing the method of the present invention;

FIG. 11a-11c shows a gemstone having a marking etched therein utilizing the method of the present invention whereby the mask is inclined to the direction of the plasma etching source such as in the embodiment examples of FIGS. 4a-4e and 5a-5e so as to provide a three-dimensional marking; and

FIG. 12 shows a further example of a data code etched into the surface of a gemstone in accordance with the method of the present invention, whereby the data code in this example is a QR code, and whereby the gemstone is a CVD (chemical vapour deposition) plate by way of example.

### DETAILED DESCRIPTION OF THE DRAWINGS

In order that a more precise understanding of the above-recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed.

As has been noted by the present inventors, identification markings including brand type markings or logos or indicia, or serial numbers or specific identifiers for a particular article as used within the prior art when applied to gemstones must be applied carefully and appropriately so as to not damage the gemstone or its optical properties, and in some embodiments and applications be invisible to the naked eye under normal optical conditions.

As also noted by the present inventors, when applying such markings to gemstones, such as diamonds, a considerable amount of time is required in respect of the setup, marking method, as well as in some cases postmarking cleaning articles to remove abraded or damaged material, depending on the marking method applied and utilized. As has been noted, there is a considerable amount of time and processing required to provide markings to gemstones, and as is known within the industry, it is important that such markings are applied in a manner so as not to detract from the optical properties of the diamond, and that there is an associated cost due to the effort and processing of a marking method.

In view of the observations by the present inventors as to the defects associated with in the prior art in respect of the marking of articles, in particular to gemstones such as diamonds, the present inventor has provided an invention of a method which:
(i) provides for the marking of multiple gemstones simultaneously;
(ii) provides for the marking of multiple gemstones which may have different or same markings applied thereto;
(iii) provides for a time effective and efficient marking method of multiple gemstones in a manner which is time and cost effective;
(iv) provides for a method which does not damage a gemstone or detract from the optical properties;
(v) provides for a method which requires minimal post-marking cleanup of gemstones;

The present inventors have identified the problem of being able to provide a marking into a solid state material, in particular a gemstone, which can be applied in an industrially acceptable and cost-effective manner with increased throughput and efficiency compared with process as utilized for the marking of such articles according to the prior art.

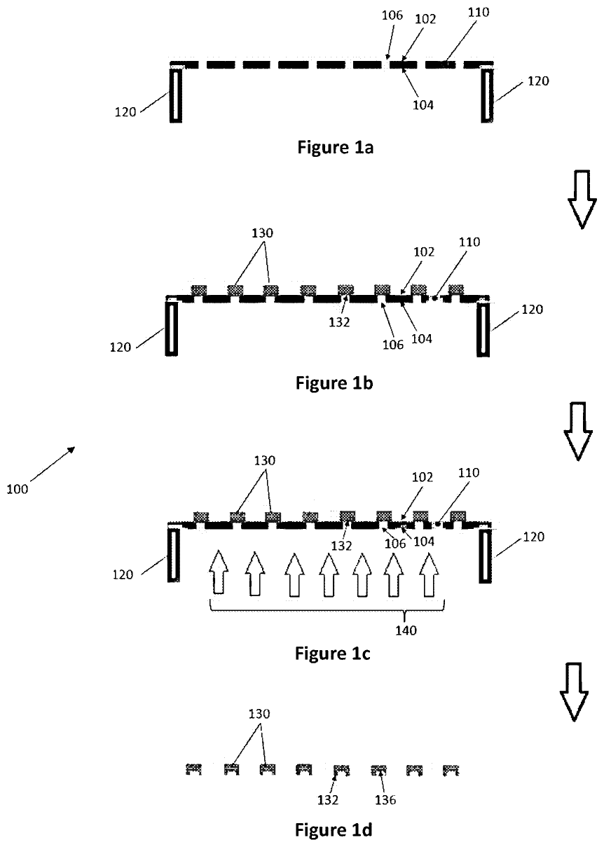

Referring to FIGS. 1a-1d, FIGS. 2a-2d, FIGS. 3a-3e, FIGS. 4a-4e, FIGS. 5a-5e and FIG. 6a, there are shown embodiments of the method of forming an identical marking at the outer surface of a plurality of articles formed from any solid state material, in accordance with the present invention.

In the present embodiment, the articles are represented as gemstones to which an identification or identifiable marking is applied, and such gemstones may be diamonds, for example natural diamonds, CVD diamonds, HPHT diamonds. Alternatively, as will be understood, the present invention is applicable to other gemstones, for example ruby, sapphire or emerald.

As will be understood by those skilled in the art, the present invention is applicable to other gemstones which are not expressly recited herein. Furthermore, as will be understood by those skilled in the art, the present invention is applicable to other solid state materials in other applications, which may not necessarily be restricted to gemstones.

As is shown, and referring to FIGS. 1a-1d, FIGS. 2a-2d and FIGS. 3a-3e, a method 100, 200, 300 according to the present invention is shown whereby a mask material 110, 210, 310 is provided, which has a first surface 102, 202, 302 and a second surface 104, 204, 304. The mask material 110, 210, 310 is supported by a support member 120, 220, 320.

As is shown in FIG. 1a, the mask 110 consists of a plurality of mask patterns 106, wherein each mask pattern is formed by one or more apertures extending through the mask 110 from the first surface 102 and to the second surface 104, and wherein the mask pattern 106 is indicative of the shape of marking to be formed on the gemstone.

In embodiments of the invention, the mask pattern 106 may be provided by various means within the mask prior to the mask being engaged with and affixed to the support member 120.

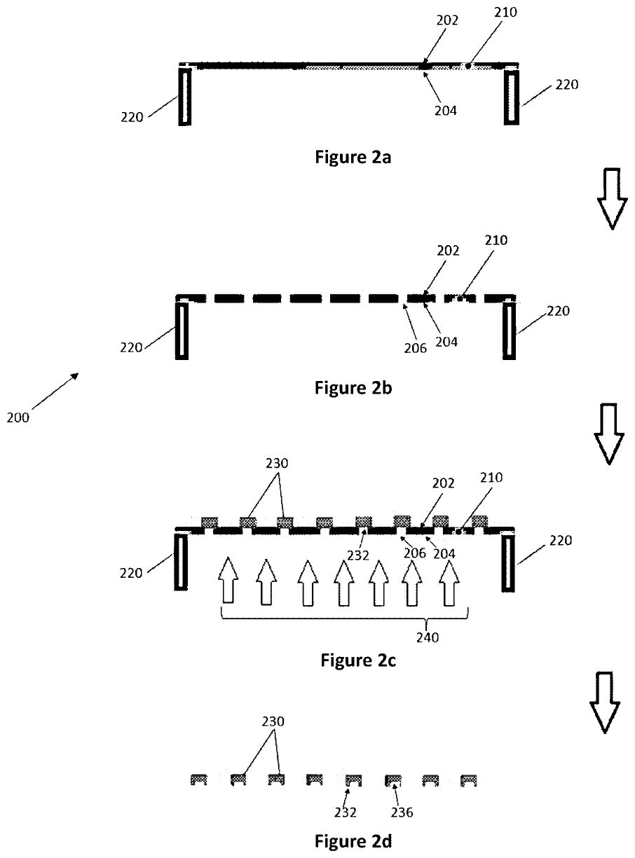

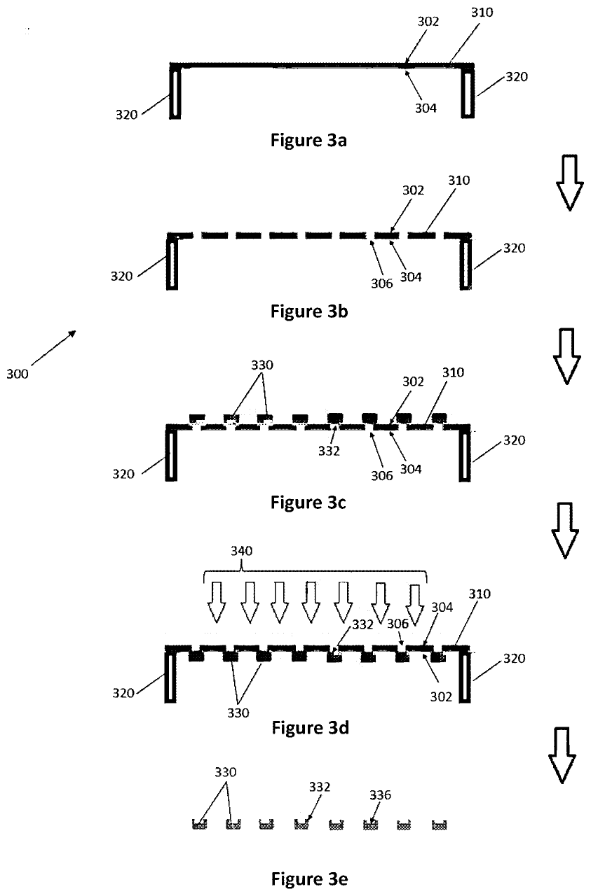

Alternatively, as is shown in FIG. 2a and FIG. 3a, in embodiments of the invention, the mask 210, 310 is provided without any mask patterns and the patterns are then formed after the mask 210, 310 is applied to support member 220, 320.

In embodiments of the present invention, mask 110, 210, 310 is formed from a polymeric material, such as a polyimide film.

The apertures forming pattern in plurality of mask patterns 206, 306 can be rapidly formed through the mask 210, 310 material by way of a laser process.

The method by way of example can utilise a laser machining system. However, in alternate and other embodiments, the apertures forming the patterns in the mask pattern may be formed by other processes for example by way of a focused ion beam process.

Each mask pattern may be different to the others, or each mask pattern may be the same as the others in embodiments of the invention.

As is shown in FIG. 1b, FIG. 2c and FIG. 3c, a plurality of articles, in the present example gemstones 130, 230, 330, are affixed relative to the mask 110, 210, 310 such that an outer surface 132, 232, 332 of each gemstone 130, 230, 330 of the plurality of articles is affixed adjacent a mask pattern 106, 206, 306, and adjacent the first surface 102, 202, 302 of the mask 110, 210, 310.

In the present embodiments, in order to affix the gemstones 130, 230, 330 relative to the mask 110, 210, 310, the mask 110, 210, 310 has an adhesive substance applied to the first surface 102, 202, 302 such that the plurality of articles 130, 230, 330 are affixed relative to the mask 110, 210, 310 by the adhesive substance. The adhesive substance is a silicon adhesive.

Then, as is shown in FIG. 1c, FIG. 2c and FIG. 3d, a plasma etching process 140, 240, 340 is applied in a direction of from towards the second surface 104, 204, 304 of the mask 110, 210, 310 and towards the plurality of gemstones 130, 230, 330, wherein the outer surface 132, 232, 332 of each gemstone 130, 230, 330 exposed to the plasma etching 140, 240, 340 through the apertures in the mask 110, 210, 310 has a marking formed thereon by one or more recesses etched by the plasma etching process 140, 240, 340.

As will be noted, in the embodiment as shown in FIG. 3a-3e, the support member 320 is inverted such that the plasma process is applied from above the plurality of gemstones 330 rather than from below the gemstones as is depicted in FIG. 1c and FIG. 2c. This inversion step is simply for ease of processing depending on the physical arrangement of the integers of the implementation of the invention, and as will be understood by those skilled in the art, irrespective of the orientation which could even be vertical, as long as the plasma process is applied in a direction of from towards the second surface 104, 204, 304 of the mask 110, 210, 310, the process is achieved such that the gemstones or other articles may be etched from the plasma etching process.

As is depicted in FIG. 1a, FIG. 2a and FIG. 3a, the plurality of gemstones 130, 230, 330, are then released from the mask 110, 210, 310 after the etching process is completed, and an etched marking as depicted by 136, 236 and 336 has been formed within the surface 132, 232, 332 of the gemstones 130, 230, 330. After the method 100, 200, 300 of the present embodiments, the plurality of gemstones 130, 230, 330 are released from the masks 110, 210, 310 by way of a releasing agent, which may be for example acetone in order to release the gemstones from the adhesive holding the gemstones to the mask.

As will be appreciated by those skilled in the art, there exist numerous ways in which the gemstones could be removed from the mask, depending on an adhesive utilized, or the manner in which the gemstones are affixed relative to the mask.

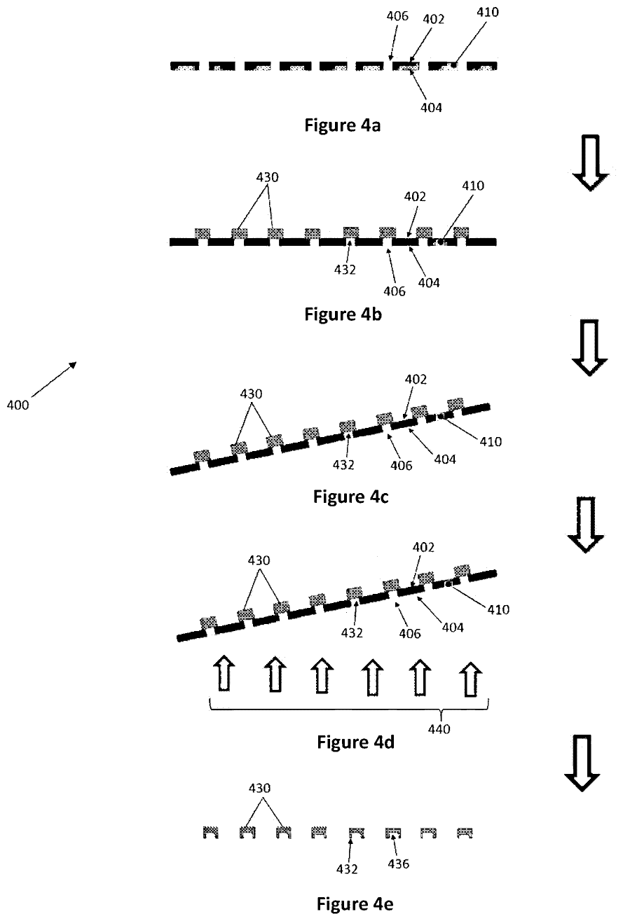

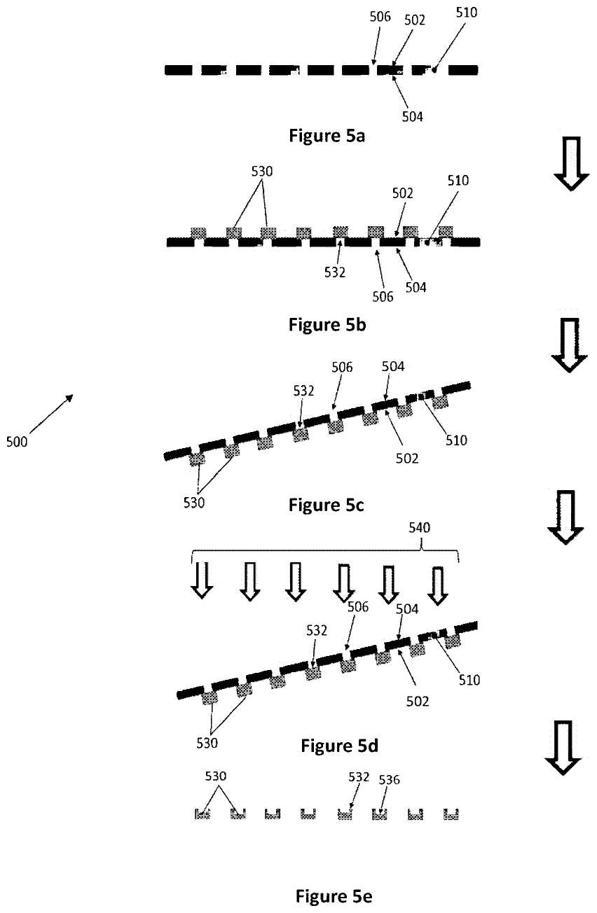

Referring now to FIGS. 4a-4e and FIGS. 5a-5e, there is shown further embodiments of the method 400, 500, in accordance with the present invention.

The method 400 is substantially the same as depicted in the previous embodiments, however, in FIG. 4c the mask 410 to which the plurality of gemstones 430 adhered thereto, is provided at an inclination with respect to the source of the plasma etching process 440.

Similarly, as is shown in FIG. 5c, the mask 510 to which the plurality of gemstones 530 is adhered thereto, is inverted and also inclined at an angle in respect of the source of the plasma etching process 540.

Then, as is depicted in FIG. 4d and FIG. 5d, due to inclination of the mask 410, 510, with respect to the plasma source 440, 540.

The gemstones 430, 530, are subsequently released from the mask 410, 510, in an appropriate manner, for example such as is described above within previous embodiments, in the event that the gemstones 430, 530, are affixed to the mask 410, 510, by way of a releasable adhesive, and a suitable releasing agent may be utilized such as acetone or the like.

The results of the etched marking 136, 236, 336, 436, 536 in the embodiments above, shall be described further below with reference to photographic representations of etched markings formed according to the embodiments above.

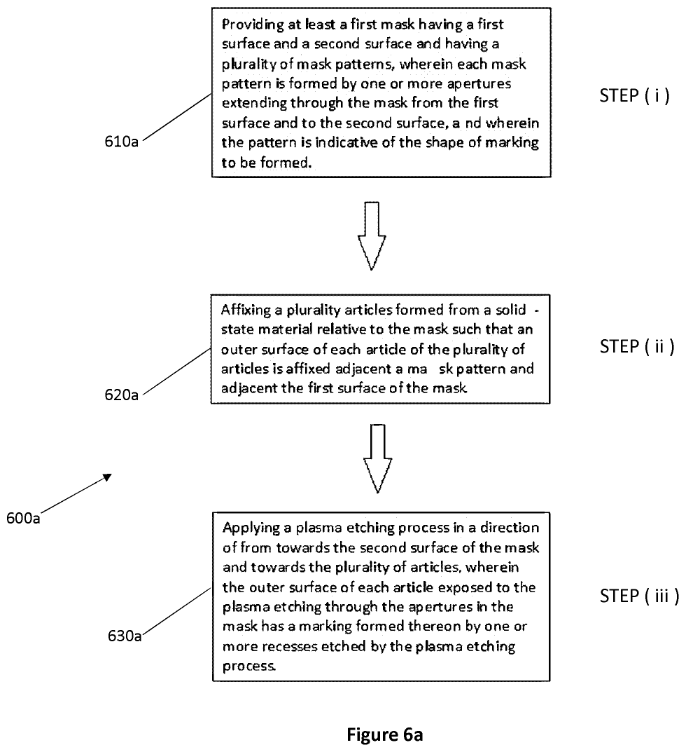

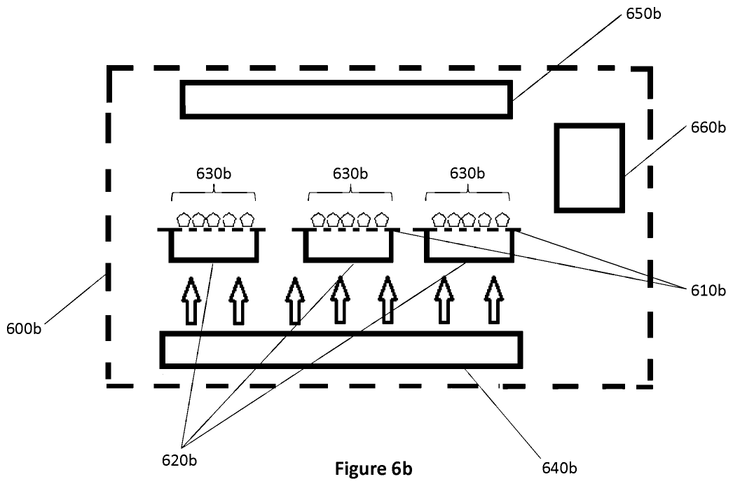

As is shown with reference to FIG. 6a, the method of the invention is depicted, which is a method 600a of forming an identifiable marking at an outer surface of a plurality of articles formed from a solid-state material, wherein each marking is formed from one or more recesses extending from the outer surface and into the article. Such a method is in keeping with that as described with reference to the preceding figures and embodiments, and the method 600a includes the steps of;
STEP (i) (610a) providing at least a first mask having a first surface and a second surface and having a plurality of mask patterns, wherein each mask pattern is formed by one or more apertures extending through the mask from the first surface and to the second surface, and wherein the pattern is indicative of the shape of marking to be formed;
STEP (ii) (620a) affixing a plurality articles formed from a solid-state material relative to the mask such that an outer surface of each article of the plurality of articles is affixed adjacent a mask pattern and adjacent the first surface of the mask; and
STEP (iii) (630a) applying a plasma etching process in a direction of from towards the second surface of the mask and towards the plurality of articles, wherein the outer surface of each article exposed to the plasma etching through the apertures in the mask has a marking formed thereon by one or more recesses etched by the plasma etching process.

Referring to FIG. 6b, there is shown a schematic representation of an example or embodiment of a system 600b according to the present invention.

As is shown, the system 600b comprises a plurality of support devices 620b each of which to support a plurality of masks 610b, each of which supports a plurality of gemstones 630b.

The manner in which the system 600b is implemented and operated, is in keeping with the method as described above in reference to FIG. 6a.

It should be noted that each of the mask patterns of each of the masks 610b may be different to each other, or the same as each other, or different to some of each other.

Alternatively, each mask may have a same mask pattern therein which may or may not be the same as the mask patterns on other masks.

In the present example, the system 600b includes a mask pattern forming device 650b, for providing and forming the mask patterns within the masks 610b, prior to the pluralities of gemstones 630b being placed upon the masks 610b.

In order to form the mask patterns, a laser system such as a laser machining system may be utilized to form such mask patterns through the masks 610b. Alternatively, other mechanisms could be used such as a focused ion beam assembly.

When using a laser machining system, the mask pattern may have a maximum width of less than 10 μm or even 5 μm can be achieved and utilized. However, when using focused ion beam, a mask pattern with a maximum width of 0.1 μm can be achieved and utilized.

By way of example, each support device 620b may support a mask 610b which may have 1000 mask patterns thereon, and for example they may be multiple support devices 620b, for example nine support devices 620b. The present inventors have found that such implementation allows for rapid and effective formation of mask patterns through the mask 610b, in a very short period of time for example 10 minutes.

The system 600b further includes a pick and place module 660b, which can rapidly place particles, such as gemstones 630b, on the mask 610b, and whereby the gemstones may be affixed to the mask 610b by way of an adhesive on the mask.

The system 600b further includes a plasma etching system 640b for etching of the markings in the plurality of gemstones 630b in accordance with the invention and in accordance with that as is described in previous embodiments directed towards the method and process of the present invention.

The plasma etching system 640b may be, for example, microwave plasma etching, reactive-ion etching (RIE), or inductively-coupled plasma (ICP) etching system.

After the requisite pattern has been etched in, the plurality of gemstones 630b may be released from the masks 610b, in a manner such as is described in reference to the above embodiments.

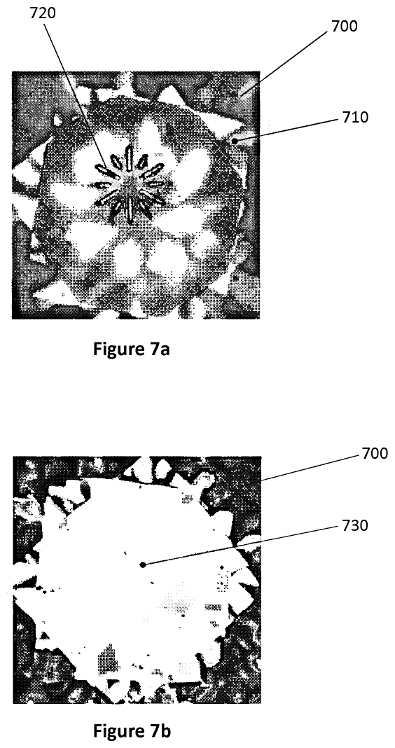

Referring to FIG. 7a, there is shown a diamond 710 releasably affixed to a mask 700 having requisite apertures 720 extending therethrough prior to etching of a mark in accordance with the present invention.

As will be understood, the layup as shown in FIG. 7a is prior to the plasma etching process as provided in accordance with the method of the present invention.

Now referring to FIG. 7b, there is now shown the diamond 710 of FIG. 7a with the marking 730 applied thereon, after etching in accordance with the method of the present invention, and prior to being removed from the mask 700.

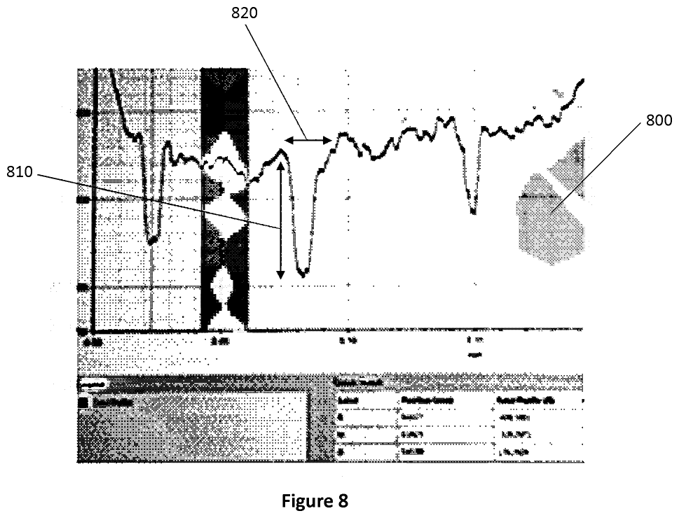

FIG. 8 shows an example 800 of etch depth variation with line width of a mask when etching a mark in accordance with the present invention. As will be understood, the present invention utilizes ARDE (aspect ratio dependent etching) and the marking pattern as provided to the mask in the present invention may be of any geometry with shape or size and as such, this allows for the design of the shape of the marking or the text of the design, and also by utilizing variance in time of the etching plasma process, the depth of the marking formed in the outer surface of the article to which is to be marked, such as a gemstone, may be varied and adjusted by utilization of both the width and size of the apertures or line width which forms the mask pattern, which can be considered to be a stencil as such.

As is seen and as will be known, for a portion of a marking for which a wider line width or size 820 is provided, the marking provided into the surface of the article will typically be deeper 810 as is shown in FIG. 8

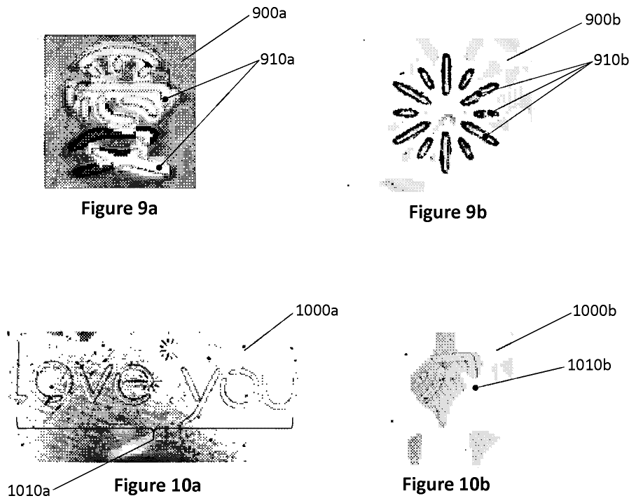

FIG. 9a and FIG. 9b show examples of a gemstone 900a, 900b etched in accordance with the method of the present invention. As is shown, the markings 910a, 910b are provided to the gemstone with a height of 300 micrometers.

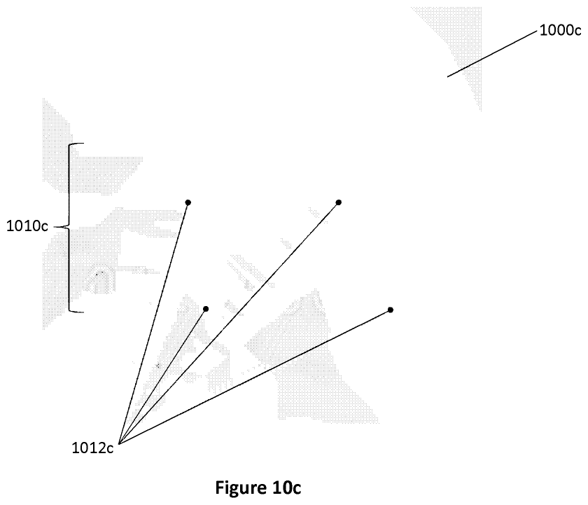

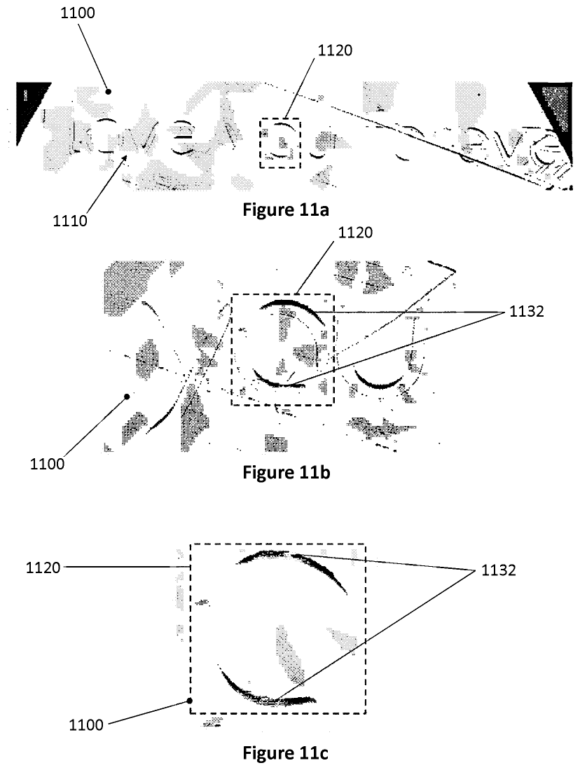

As is shown in FIG. 10a and FIG. 10b, there are shown further examples of gemstones 1000a, 1000b etched with markings 1010a, 1010b in accordance with the present invention. In the present examples, the gemstones are emerald gemstones 1000a, 1000b with a marking etched into the surface thereof utilizing the method of the present invention.

FIG. 10c shows an example of a CVD (chemical vapour deposition) plate 1000c with a marking 1010c etched into the surface thereof utilizing the method of the present invention, and whereby the marking is comprised of several elements 1012c including a combination of text, letters and numerals.

It should be noted that examples as shown in FIG. 7a through FIG. 10c have been marked according to the method and the implementation as described in reference to FIGS. 1a through 3a.

However, FIGS. 11a-11c show a gemstone 1100 having a marking 1110 etched therein utilizing the method of the present invention whereby the mask is inclined to the direction of the plasma etching source such as in the embodiment examples of FIGS. 4a-4e and 5a-5e so as to provide a 3-dimensional marking.

As is shown in the focused section 1120 of FIG. 11a, which is a letter “O”, formed in two sections, the portion of the marking 1132 extending from the outer surface of the gemstone 1100 is inclined to the outer surface and has been provided in a 3-dimensional arrangement in accordance with the present invention. As will be understood by those skilled in the art, by inclining the mask with respect to the emission from the plasma etching source has allowed the present inventors to provide a mark with three dimensional characteristics.

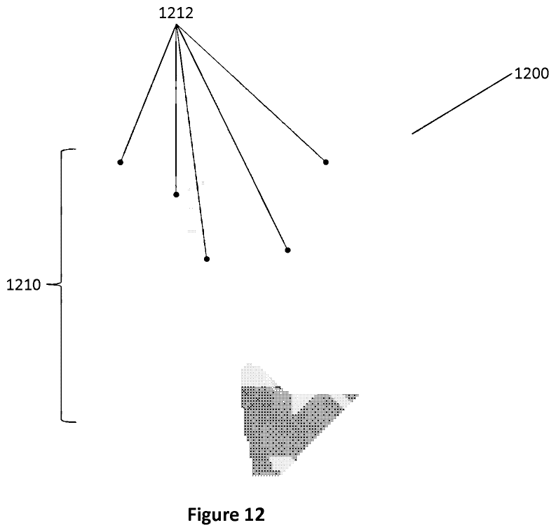

Referring to FIG. 12, there is show an example of a data code 1210 etched into the surface of a gemstone 1200 in accordance with the method of the present invention, whereby the data code in this example is a QR code, being formed from a plurality of etchings 1212. In the present example, the gemstone 1200 is a CVD (chemical vapour deposition) plate.

As will be understood, the provision of the QR code in accordance with the present invention allows for an individual marking and many markings which are unique to be provided to gemstones, each of which may be linked to the particulars of the diamond, including the size, the clarity, the color and the cut as well as any other information such as the origin as well as the owner of the gemstone.

The method and system of the present invention allows for the marking of numerous articles in a short period of time, addressing shortcomings of the prior art, in particular in relation to the marking of gemstones.

The present inventors have overcome the deficiencies of the prior art and have provided a system and method useful in the marking of articles in particular gemstones, which can allow for the rapid marking of many gemstones at the same time, all of which may have the same marking thereon, or may have unique different markings or identifiers on each gemstone or a mixture thereof.

The present invention allows for the marking including patterns, indicia, branding, logos, serial numbers, data codes, QR codes and the like.

The method allows for versatility in respect of the markings to be provided to gemstones, and can provide a marking which is not optically detectable by the naked eye so as not to interfere with the optical properties of the gemstones and not detract from the value or cause unsightly blemishes or imperfections which inevitably are undesirable for gemstones.

The markings as provided by the present invention provide significant details, and can provide information non-discernible to the naked eye, yet can be indicative of the details of a gemstone, such that the identification of a particular gemstone can be provided. As is known by those skilled in the art, reliable marking of gemstones as well as being able to provide unique marks as well as logos and brands, is necessary within the gemstone marking industry.

The present inventors have found that by providing a mask made by a polymeric material, can be useful in embodiments of the invention.

In embodiments of the invention, the present inventors have found that by providing a mask material with an adhesive layer, that gemstones can be affixed to the mask sufficiently and readily during the marking method by way of plasma etching.

Furthermore, as the present invention utilizes ARDE (aspect ratio dependent etching) processes, the present inventors have found that sufficient flexibility is provided so as to provide unique markings with precision and details, as well as patterns and trademarks for example.

The present inventors have provided a mask in accordance with the present invention, whereby the mask thickness may be in the range of from 10 μm to 800 μm, or in the range of from 25 μm to 400 μm, or in the range of from 40 μm to 200 μm. The mask may have a thickness of about 50 μm.

By utilizing laser machining techniques or focused ion beam, the apertures of mask pattern have a width of in the range of from 0.1 μm to 100 μm, which have been found useful in accordance with the method of the present invention.

Further, the present inventors have found that by having an aspect ratio of the mask thickness to the width of the apertures of the mask pattern is in the range of from 3:1 to 15:1, a suitable marking can be formed by plasma etching in accordance with the present invention.

In accordance with the invention, each mask pattern of the plurality of mask patterns may be the same as the other mask patterns, each mask pattern of the plurality of mask patterns differs from at least one of the other mask patterns. Each mask pattern may be formed by a plurality of apertures extending through the mask. The apertures of the mask patterns may have different sizes and shapes.

The width of the apertures of the pattern is of a constant width and the depth of the marking etched into the article is a constant depth. Alternatively, the width of the apertures of the pattern may be of a varied width and the depth of the marking etched into the article is a varied depth.

The depth of the marking in accordance with the present invention does not necessarily have a particular depth limitation, however a marking which may be suitable for the marking of gemstones may be provided by the present invention which has a depth in the range of from 10 nm to 30 nm, for example.

The present invention is particularly useful for the marking of gemstones, such as diamond including natural diamond, synthetic diamond, CVD diamond and HPHT diamond.

The present invention is also useful for the marking of other gemstones such as ruby, sapphire and emerald.

Particular advantages of the present invention include:
provides for the marking of multiple gemstones simultaneously;
provides for the marking of multiple gemstones which may have different or same markings applied thereto;
provides for a time-effective and efficient marking method of multiple gemstones in a manner which is time and cost effective;
provides for a method which does not damage a gemstone or detract from the optical properties;
provides for a method which requires minimal post-marking cleanup of gemstones;
a marking which, when applied to articles such as precious stones or gemstones, allows for the identification for security purposes as well as tracking and origin of the articles.

The marking method and marking from such method of the present invention provides the following further advantages:
(i) security purposes, which may be utilized to mitigate or identify counterfeiting, and impropriety including theft and the like;
(ii) marking of a solid-state material, without the disadvantages associated with other destructive and invasive methods of marking such as ablation, milling, engraving and the like;
(iii) a methodology and product thereof which does not alter the optical qualities or properties of a solid-state material, and which is not detrimental to the clarity or colour of the solid-state material;
(iv) a methodology and product thereof, which does not introduce contaminants or impurities to the solid-state material;
(v) a methodology and product thereof, having no associated chemical residue;
(vi) provides for a method which does not impact on the occupational health and safety (OHS) of workers using such a method;
(vii) minimal waste disposal and obviates the necessity of the toxic or highly volatile.

It should be noted and understood that the embodiments of the present invention illustrate the idea and principle, not limitation. In these embodiments the methodology and the implementation mechanism may be modified or substituted for an efficient presentation without departing from the scope of the invention. Thus, the appended claims are not to be limited by the embodiments.

The term “marking” is used throughout the description and claims, and such a “marking” will be understood by those skilled in the art to pertain to a “mark” provided to the surface of an article, and the terms are synonymous with each other and may be used interchangeably without alteration of meaning or interpretation. Also, as should be understood, marking may be provided as a single edge, for multiple edges which collectively may form a marking or identification mark. A marking may be a geometrical shape or a plurality of geometric shapes, as well as a brand or logo, indicia, serial number or other marking which is indicative of a particular article to which the marking is applied. As also will be understood, markings may be unique in their own right, or alternatively may be the same for a series of article to indicate a batch or lot of articles.

Also, as will be understood, a marking may be a data marking such as a QR code, which may be indicative of the identification of a particular article, or certain attributes of an article, and allow for tracing and look up of data specific to an article with a unique data code, or a series of articles which may share a common data code, or a portion of the data code may indeed be common between a set of articles.

Nonetheless, regardless of what type of marking, with unique or series or branding, the one or more recesses as provided to an article in accordance with the present invention are considered to be a marking or an identifier.

1. A method of forming an identifiable marking at an outer surface of a plurality of articles formed from a solid-state material, wherein each marking is formed from one or more recesses extending from the outer surface and into the article, said method including the steps of:
(i) providing at least a first mask having a first surface and a second surface and having a plurality of mask patterns, wherein each mask pattern is formed by one or more apertures extending through the mask from the first surface and to the second surface, and wherein the pattern is indicative of the shape of marking to be formed;
(ii) affixing a plurality of articles formed from a solid-state material relative to the mask such that an outer surface of each article of the plurality of articles is affixed adjacent a mask pattern and adjacent the first surface of the mask; and
(iii) applying a plasma etching process in a direction of from towards the second surface of the mask and towards the plurality of articles, wherein the outer surface of each article exposed to the plasma etching through the apertures in the mask has a marking formed thereon by one or more recesses etched by the plasma etching process.

2. The method according to claim 1, wherein the plasma etching process is microwave plasma etching, reactive-ion etching (RIE), or inductively-coupled plasma (ICP) etching.

3. The method according to claim 1, wherein the mask is formed from a polymeric material.

4. (canceled)

5. The method according to claim 1, wherein the mask has an adhesive substance applied to the first surface, and wherein the plurality articles are affixed relative to the mask by said adhesive substance.

6. (canceled)

7. The method according to claim 1, wherein the etching process is an ARDE (aspect ratio dependent etching) process.

8. The method according to claim 1, wherein the mask thickness is in the range of from 10 μm to 800 μm,
wherein the mask thickness is in the range of from 25 μm to 400 μm,
wherein the mask thickness is in the range of from 40 μm to 200 μm, or
wherein the mask thickness of is about 50 μm.

9.-11. (canceled)

12. The method according to claim 1, wherein the apertures of mask pattern have a width of in the range of from 0.1 μm to 100 μm,

13. The method according to claim 1, wherein the aspect ratio of the mask thickness to the width of the apertures of the mask pattern is in the range of from 3:1 to 15:1 and wherein the aspect ratio of the mask thickness to the width of the apertures of the mask pattern is preferably about 5:1.

14. (canceled)

15. The method according to claim 1, wherein each mask pattern of the plurality of mask patterns is the same as the other mask patterns or wherein each mask pattern of the plurality of mask patterns differs from at least one of the other mask patterns.

16. (canceled)

17. The method according to claim 1, wherein each mask pattern is formed by a plurality of apertures extending through the mask and wherein the apertures of the mask patterns may have different sizes and shapes.

18. (canceled)

19. The method according to claim 1, wherein the mask pattern is provided as an indicia, so as to provide for an indicia to be etched into the outer surface of the article wherein the mask pattern is provided as a serial number, so as to provide for a serial number to be etched into the outer surface of the article,
wherein the mask pattern is provided as a data code indicia, so as to provide for a data code indicia, to be etched into the outer surface of the article,
where in the data code in a QR code, or
wherein the marking is an etched 2-dimensional marking or a 2.5-dimensional marking.

20.-23. (canceled)

24. The method according to claim 1, wherein the width of the apertures of the pattern is of a constant width and the depth of the marking etched into the article is a constant depth,
wherein the width of the apertures of the pattern is of a varied width and the depth of the marking etched into the article is a varied depth, or
wherein the mask is inclined at an angle with respect to the direction of the plasma etching process, such that a side surface of the edged marking is inclined with respect to the outer surface of the article in which the marking is etched, such that the marking is of a 3-dimensional form.

25.-26. (canceled)

27. The method according to claim 1, wherein the marking has a depth in the range of from 10 nm to 30 nm, and wherein the marking has a depth of about 20 nm.

28.-29. (canceled)

30. The method according to claim 1, wherein the plasma etching step (iii) is provided for a time in the range of between 10 minutes and 20 minutes, and, wherein the plasma etching step (iii) is provided for a time of about 15 minutes.

31.-33. (canceled)

34. The method of claim 1, wherein the apertures forming the patterns in the mask are formed by way of a laser process, wherein the laser process is provided by a laser machining system, or wherein the apertures forming the patterns in the mask are formed by way of a focused ion beam process.

35.-36. (canceled)

37. The method according to claim 1, wherein the solid state material from which the articles are formed includes a gemstone.

38. The method according to claim 37, wherein the gemstone is diamond, and wherein said diamond includes natural diamond, synthetic diamond, CVD diamond and HPHT diamond, or wherein the gemstone includes ruby, sapphire and emerald.

39.-40. (canceled)

41. The method according to claim 1, wherein the marking is viewable by use of a 10× loupe or a 20× loupe or wherein the marking is viewable under a 5× or 10× microscope.

42.-45. (canceled)

46. An article having thereon a marking formed according to the method of claim 1,
wherein the solid state material from which the article is formed includes a gemstone,
wherein the gemstone is diamond, and
wherein said diamond includes natural diamond, synthetic diamond, CVD diamond and HPHT diamond, or
wherein the gemstone includes ruby, sapphire, and emerald.

47.-52. (canceled)

53. The article according to any one of claim 46, wherein the marking is viewable by use of a 10× loupe or a 20× loupe or is viewable under a 5× or 10× microscope.

54. (canceled)

55. A system for forming an identifiable marking at an outer surface of a plurality of articles formed from a solid-state material, comprising:
a plurality of support devices for supporting at least a first mask having a first surface and a second surface and having a plurality of mask patterns, wherein each mask pattern is formed by one or more apertures extending through the mask from the first surface and to the second surface, and wherein the pattern is indicative of the shape of marking to be formed; and
a plasma etching system applying a plasma etching process in a direction of from towards the second surface of the mask and towards a plurality of articles, wherein the outer surface of each article exposed to the plasma etching through the apertures in the mask has a marking formed thereon by one or more recesses etched by the plasma etching process.

56. The system according to claim 55, further comprising a mask pattern forming device for providing and forming the mask patterns within the masks prior to the plurality of gemstones being placed upon the masks and wherein the system may further comprise a pick and place module for placing articles adjacent the mask patterns prior to etching the marking.

57. (canceled)
